(19) United States
(12) Patent Application Publication
(10) Pub. No.: US 2026/0312392 A1
(43) Pub. Date: Oct. 8, 2026

(54) CABLE MANAGEMENT IN VEHICLE CHARGING SYSTEMS

(71) Applicant: PROLOGIS, L.P., San Francisco, CA (US)

(72) Inventors: Casper Jan-Theo Hendrik Steenkamp, San Francisco, CA (US); Christopher Ryan Wajsen, Foothills (CA)

(21) Appl. No.: 19/171,151

(22) Filed: Apr. 4, 2025

(51) Int. Cl. H02G 11/00; B60L 53/16; B60L 53/18; B60L 53/31; H02J 7/00

(52) U.S. Cl. CPC H02G 11/00; B60L 53/16; B60L 53/18; B60L 53/31; H02J 7/70

(57) ABSTRACT

The present technology is generally directed to cable management in charging system and a method of using thereof. In various embodiments, the charging system including: a smart post; a charging post; and a cable management system comprising: a guide assembly including a plurality of sheaves to guide movement of an electrical cable; and a suspension cable having a first end coupled to the guide assembly and a second end operatively associated with the smart post, the suspension cable being configured to facilitate controlled movement of the guide assembly. In some embodiments, the charging system includes a skid on which the smart post and the charging post are mounted.

### TECHNICAL FIELD

The present technology generally relates to vehicle charging systems, and in particular to cable management in vehicle charging systems and associated devices and methods.

### BACKGROUND

As the adoption of electricity-powered vehicles, including electric vehicles (EVs) and hybrid vehicles, continues to grow, the demand for reliable and efficient charging infrastructure is expected to increase correspondingly. This trend reflects the ongoing transition to electrified transportation and the need for systems capable of supporting widespread vehicle charging across diverse applications.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIGS. 1A through 1E are perspective, front, rear, right, and left views, respectively, of an electric vehicle (EV) charging island system configured in accordance with embodiments of the present technology.

FIG. 2 illustrates a perspective view of a charging unit, in accordance with embodiments of the present technology.

FIGS. 3A through 3C illustrate various views of a charging unit in a retracted configuration, in accordance with some embodiments of the present disclosure.

FIGS. 4A and 4B illustrate various views of a charging unit in an extended configuration, in accordance with some embodiments of the present disclosure.

FIGS. 5A through 5D illustrate various views of a counterweight assembly, in accordance with some embodiments of the present disclosure.

FIGS. 6A through 6G illustrate various views of a guide assembly, in accordance with some embodiments of the present disclosure.

FIGS. 7A and 7B illustrate various views of a pulley assembly, in accordance with some embodiments of the present disclosure.

FIGS. 8A through 8F illustrate various views of a pulley assembly, in accordance with some embodiments of the present disclosure.

FIG. 9 is a flowchart illustrating a process for charging a vehicle using a cable management system, in accordance with some embodiments of the present disclosure.

A person skilled in the relevant art will understand that the features shown in the drawings are for purposes of illustrations, and variations, including different and/or additional features and arrangements thereof, are possible.

### DETAILED DESCRIPTION

Aspects of the present disclosure relate to cable management in an electric vehicle (EV) charging system and a method of using the same. The rapid charging of EVs, including heavy-duty electric vehicles, operates at high power and amperage levels, often involving the use of thick and heavy electrical cables and connectors. Such a charging cable assembly (including an electrical cable and connector) can be challenging for a user (e.g., a driver) to maneuver into position and connect to an EV, creating significant usability challenges. Furthermore, the bulk and weight of the charging cable assembly often lead users to leave it on the ground or drag it during use. This improper handling can result in abrasion of the electrical cable and damage to the connector, increasing the need for frequent cable replacement and driving up maintenance costs.

Embodiments of the present technology address at least some of the above described issues by providing a cable management system. For example, the charging system includes a skid, a smart post attached to and extending away from the skid; a charging post mounted on the skid; and a cable management system. The cable management system includes: a guide assembly including a plurality of sheaves to guide movement of an electrical cable; and a suspension cable having a first end coupled to the guide assembly and a second end operatively associated with the smart post, the suspension cable being configured to facilitate controlled movement of the guide assembly. The sheaves may be rotatable to ease the movement of the electrical cable.

Additionally or alternatively, the cable management system may include a counterweight assembly and/or a pulley assembly. The counterweight assembly is configured to configured to suspend or support the charging cable assembly. The counterweight assembly enables the electrical cable and the connector to remain suspended above the ground, ensuring proper alignment and protecting it from wear and tear. The pulley assembly is configured to guide the suspension cable and control the movement of the guide assembly, facilitating smooth extension and retraction of the charging cable assembly. The pulley assembly may include a ratchet mechanism to allow unidirectional movement during pulling and to lock the cable in place during charging, as well as a disengagement feature to allow bidirectional movement for retraction.

Embodiments of the present technology can also include a method for charging a vehicle. The method can include moving a guide assembly of a cable management system by moving a charging cable assembly that includes an electrical cable and a connector at an end of the electrical cable. The guide assembly includes a plurality of sheaves configured to moveably support the electrical cable. The cable management system further includes a suspension cable having a first end coupled to the guide assembly and a second end operatively associated with a smart post. The suspension cable being configured to facilitate controlled movement of the guide assembly. The method further includes connecting the connector to a charging port of the vehicle to allow charging of the vehicle; maintaining a position of the connector during charging by controlling movement of the guide assembly via the suspension cable; disconnecting the connector from the charging port; and allowing the charging cable assembly to retract through controlled movement of the guide assembly via the suspension cable.

Embodiments of the present technology enable several advantages. By suspending the charging cable assembly above the ground, the cable management system prevents damage from abrasion and improper handling, such as dragging or dropping the cable. The counterweight assembly reduces the physical effort it takes for the user to maneuver the charging cable assembly, making the charging process more user-friendly, e.g., for thick and heavy cables used in high-power EV charging. Furthermore, the controlled movement of the guide assembly via the suspension cable ensures smooth and secure extension and retraction of the cable assembly, minimizing wear and tear on both the cable and the connector. The ratchet mechanism in the pulley assembly enables stability by locking the cable in place during charging, while the retraction feature ensures that the cable is returned to its starting position after use, preventing clutter and improving overall system organization. These features collectively enhance durability, usability, and maintenance efficiency in charging systems.

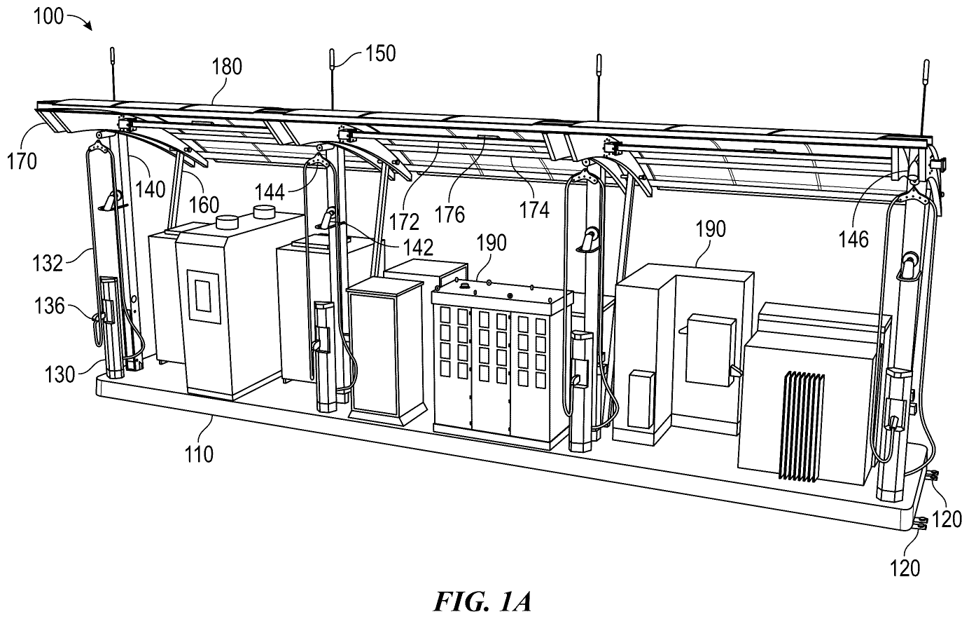

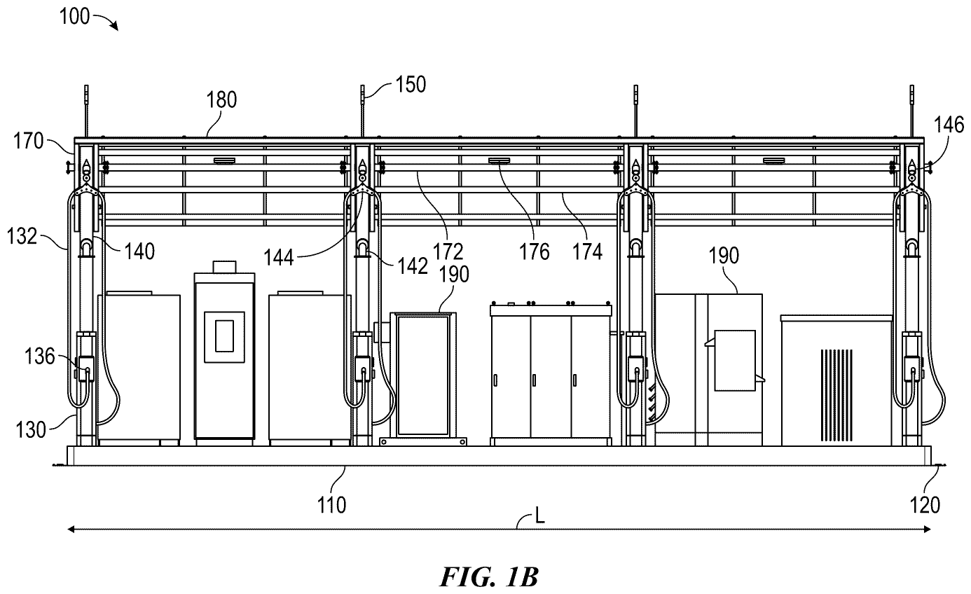

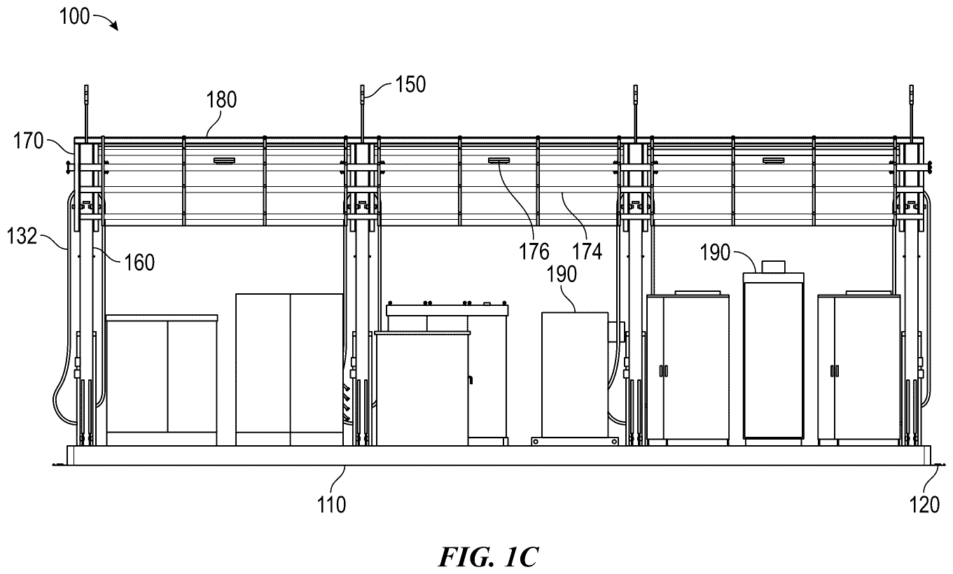

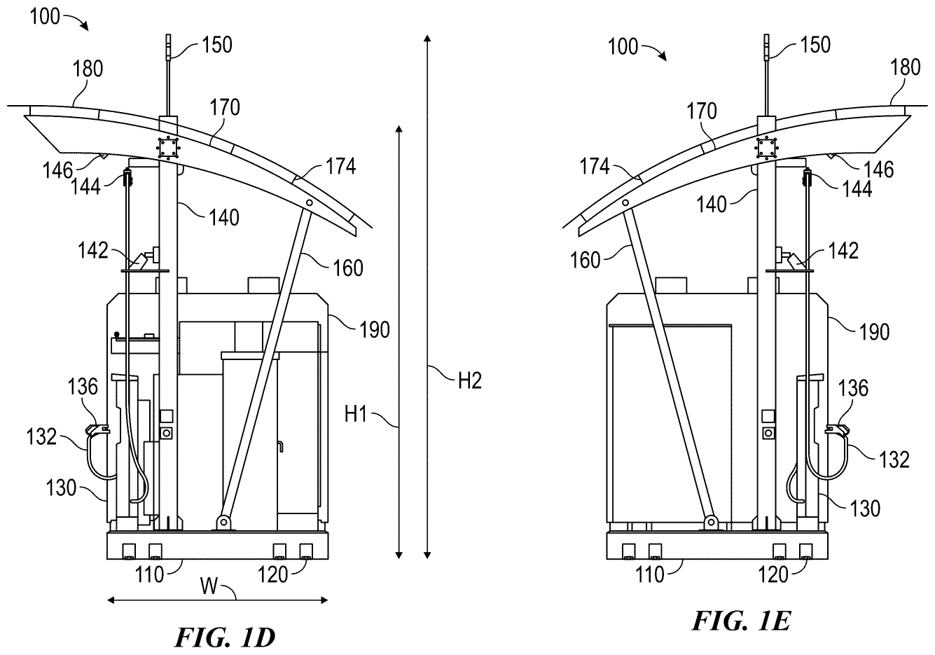

Specific details of several embodiments of the present technology are described herein with reference to FIGS. 1A-9. The present technology, however, can be practiced without some of these specific details. In some instances, well-known structures and techniques often associated charging of vehicles, and the like, have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

FIGS. 1A-1E are perspective, front, rear, right, and left views, respectively, of an electric vehicle (EV) charging system 100 (“system 100”) configured in accordance with embodiments of the present technology. Referring to FIGS. 1A-1E together, the system 100 can include a skid 110, a plurality of charging posts 130, a plurality of smart posts 140, a plurality of support struts 160, a canopy 180, and a plurality of electrical components 190.

The skid 110 can have a generally flat form and can serve as a platform for the other components of the system 100. In the illustrated embodiment, the skid 110 has a generally rectangular shape with rounded corners. The skid 110 can have a length L (FIG. 1B) between about 400-600 inches (e.g., 516 inches) and a width W (FIG. 1D) between about 80-120 inches (e.g., 96 inches). The skid 110 can also include a plurality of anchors 120 that can releasably secure the skid 110 (and thus the entire system 100) onto a surface, such as metal, cement, or other substrate on-site. In the illustrated embodiment and as best seen in FIGS. 1D and 1E, the skid 110 includes four pairs of anchors 120, each pair positioned along either the left or right sidewall of the skid 110 and adjacent to either the front or rear wall of the skid 110.

The plurality of charging posts 130 can each be mounted on the skid 110. In particular, in the illustrated embodiment, a first charging post 130 is mounted on the front-left corner of the skid 110, a second charging post 130 is mounted on the front-right corner of the skid 110, a third charging post 130 is positioned between the first and second charging posts 130, and a fourth charging post 130 is positioned between the second and third charging posts 130. In some embodiments, adjacent charging posts 130 are spaced apart equally. Each charging post 130 can include a charging cable (or referred to as electrical cable) 132 and a connector 136 that a user can connect to an electric vehicle (EV) to charge the EV.

The plurality of smart posts 140 can each be mounted on the skid 110. In particular, in the illustrated embodiment, a first smart post 140 is positioned adjacent to and rear of the first charging post 130, a second smart post 140 is positioned adjacent to and rear of the second charging post 130, a third smart post 140 is positioned adjacent to and rear of the third charging post 130, and a fourth smart post 140 is positioned adjacent to and rear of the fourth charging post 130. As illustrated in FIGS. 1A-1E, the plurality of smart posts 140 can each include a vertical column and can together support the canopy 180 thereon. In some embodiments, each smart post 140 also includes a camera 142, a cable guide assembly 144, a light source 146, and an indicator 150, each mounted on the vertical column. The camera 142 can be positioned above the corresponding charging post 130 and oriented to face the area forward of the corresponding charging post 130. Therefore, the cameras 142 can capture, e.g., the EVs and/or personnel using the system 100. Each cable guide assembly 144 can be positioned above the corresponding camera 142 and can support (e.g., suspend) the charging cable 132 of the corresponding charging post 130. Each light source 146 can be positioned above the corresponding cable guide assembly 144 and can be oriented to illuminate the area forward of the corresponding charging post 130. Each indicator 150 can extend upward from the vertical column and above the canopy 180.

The plurality of support struts 160 can each be mounted on the skid 110. In particular, in the illustrated embodiment, a first support strut 160 is positioned adjacent to and rear of the first smart post 140, a second support strut 160 is positioned adjacent to and rear of the second smart post 140, a third support strut 160 is positioned adjacent to and rear of the third smart post 140, and a fourth support strut 160 is positioned adjacent to and rear of the fourth smart post 140. As illustrated in FIGS. 1A-1E, the plurality of support struts 160 can each extend upward from the skid 110 at a rearward angle. Each pair of a smart post 140 and a support strut 160 can support a pair of a plurality of arched beams 170.

The canopy 180 can be mounted on the plurality of arched beams 170. More specifically, the system 100 can further include a plurality of canopy support beams 174 each coupled to upper surfaces of the plurality of arched beams 170 and extending laterally thereacross. As illustrated in FIGS. 1D and 1E, different ones of the plurality of canopy support beams 174 (e.g., I-beams) can be coupled to different points along the curvature of the arched beams 170. The canopy 180 can be mounted on the plurality of canopy support beams 174. As best seen in FIGS. 1D and 1E, the canopy 180 can have a curvature corresponding to the curvature of the plurality of arched beams 170 such that, e.g., a front portion of the canopy 180 is substantially horizontal and a rear portion of the canopy 180 is angled. In some embodiments, the canopy 180 includes solar panels that can, e.g., power or charge one or more of the electrical components 190.

Referring to FIG. 1D, the system 100 can have a first height H1 excluding the indicators 150 (e.g., up to the highest portion of the canopy 180) and a second height H2 including the indicators 150. The first height H1 can be between about 180-220 inches (e.g., 193 inches). The second height H2 can be between about 200-250 inches (e.g., 227 inches). It is appreciated that the given ranges of the length L, the width W, the first height H1, and the second height H2 are merely illustrative example ranges, and that each dimension can be smaller or greater than the given ranges.

The system can further include a plurality of horizontal beams 172 and a plurality of lighting devices 176. Each horizontal beam 172 can extend between adjacent pairs of the plurality of arched beams 170 and below the canopy 180. The plurality of lighting devices 176 can each be mounted on one of the horizontal beams 172. One, two, or more lighting devices 176 can be mounted on each horizontal beam 172. The lighting devices 176 can be oriented to illuminate a lower surface of the canopy 180. In some embodiments, the canopy 180 is composed of polycarbonate or other transparent/translucent material such that the canopy 180 can both (i) allow sunlight to pass through and (ii) reflect the light emitted by the plurality of lighting devices 176 to indirectly illuminate the area below the canopy 180.

The plurality of electrical components 190 can each be mounted on the skid 110 and can include one or more types of devices suitable for delivering charge to EVs connected to the charging cables 132 and the connectors 136. For example, the plurality of electrical components 190 can include at least one, two, three, four, or more of the following: a generator set, a battery, a transformer, a converter, a splitter, an inverter, a network box, and/or the like. It is appreciated that the specific electrical components to be included in the system 100 can be customized for the specific application. For example, if the system 100 is to be connected to a power grid such that EVs can be charged via utility power, one or more transformers can be included among the plurality of electrical components 190. If the system 100 is to be connected to a power grid and capable of generating and storing energy, one or more transformers, one or more generator sets, and one or more batteries can be included among the plurality of electrical components 190. If the system 100 is not to be connected to a power grid (e.g., due to the location of the installation site), one or more generator sets and/or one or more batteries can be included among the plurality of electrical components 190 (e.g., without a transformer). In some embodiments, the arrangement of the plurality of electrical components 190 can be selected to evenly distribute the weights thereof on the skid 110.

In some embodiments, the system 100 further includes a plurality of lifting lugs (not shown in FIGS. 1A-1E). The lifting lugs can be permanently or removably mounted on the skid 110, and can facilitate handling of the system 100 during, e.g., installation of the skid 110 onto a surface.

It is appreciated that the illustrated embodiment of the system 100 in FIGS. 1A-1E is merely one example, and that various features of the system 100 can be modified within the scope of the present technology. For example, (i) the skid 110 can include a different number and/or arrangement of the anchors 120, (ii) the skid 110 can have different shapes and/or dimensions, (iii) the system 100 can include a different number of charging posts 130, smart posts 140, and/or support struts 160, (iv) the canopy 180 can have a different shape and/or size, (v) the plurality of electrical components 190 can vary, and/or the like. Additionally or alternatively, one or more components (e.g., the plurality of lighting devices 176) can be omitted from and/or additional components not shown (e.g., cables extending through the skid 110) can be included in the system 100.

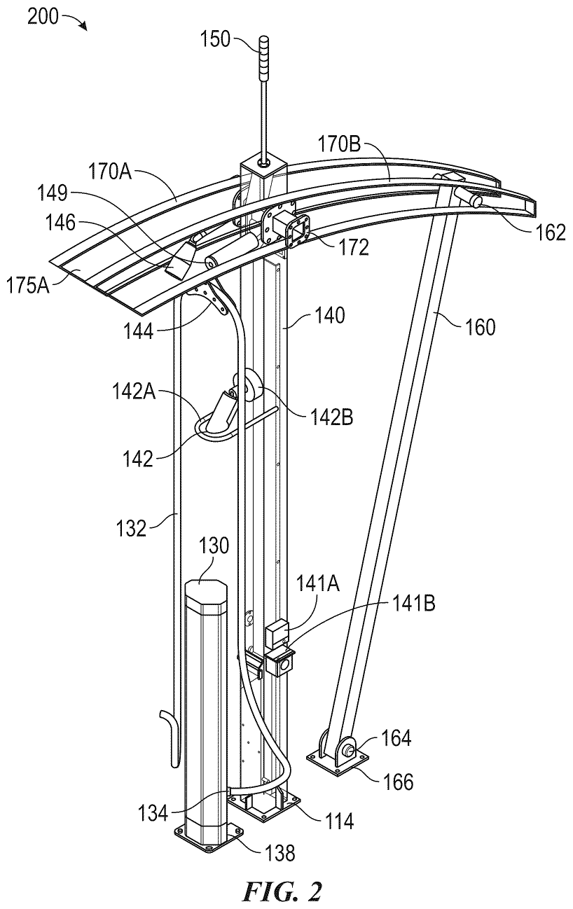

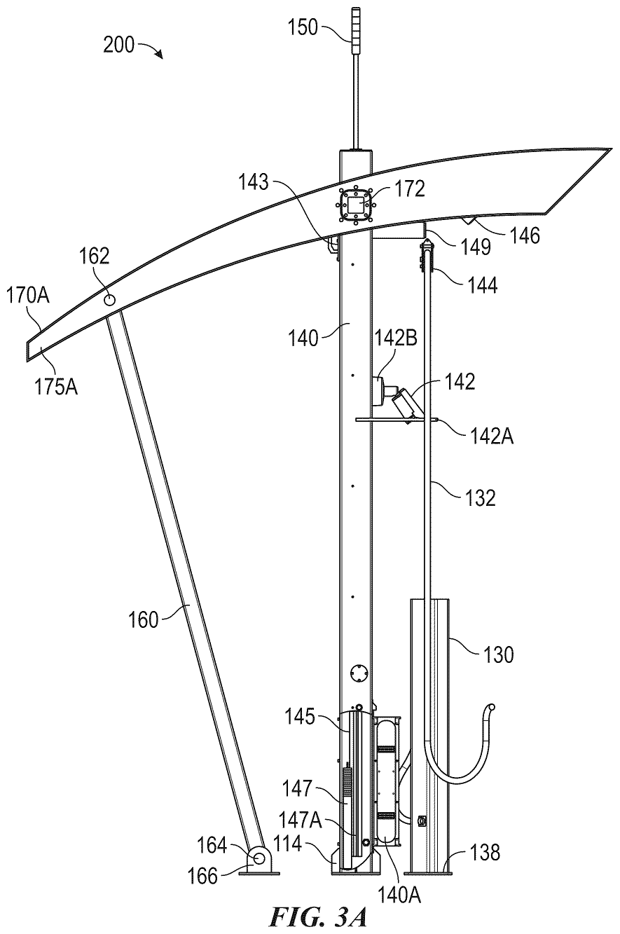

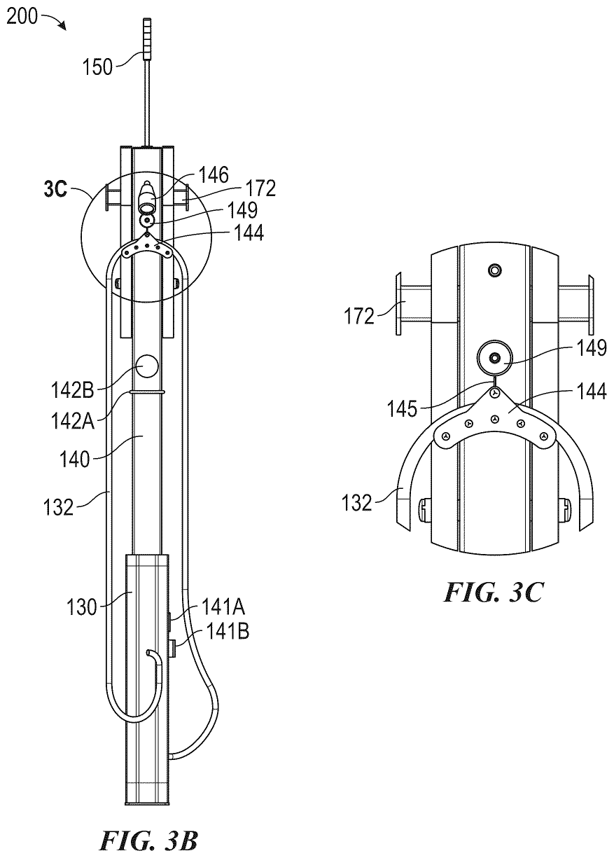

FIG. 2 illustrates a perspective view of a charging unit, in accordance with embodiments of the present technology. The charging unit 200 (“unit 200”) includes a charging post 130 and a smart post 140. The charging post 130 includes a charging cable assembly with a charging cable (or referred to as electrical cable) 132. The electrical cable 132 has a connector 136 at one end and electrically connects to the charging post 130 through a connection point 134. The connector 136 is configured to be connected to a charging port of a vehicle to allow charging of the vehicle. The vehicle may be an EV, a hybrid vehicle, etc. The smart post 140 includes an indicator 150, a light source (e.g., a floodlight) 146, a camera 142 with a protective bar 142A. The camera 142 is mounted on the smart post 140 via the base 142B. Additionally or alternatively, the smart post 140 includes an intercom 141A and emergency stop 141B at a user-accessible height. The emergency stop 141B may include a protective cover (e.g., plastic or glass cover) that can be broken by a user to access the emergency stop button in case of emergency, while reducing the risk of accidental activation. The smart post 140 includes a cavity along its length for housing additional components therein. The smart post 140 includes a cover plate (e.g., 140A as illustrated in FIG. 3A) to allow access to the cavity.

The charging post 130 mounts to the skid 110 via a base plate 138. The smart post 140 connects to the skid 110 via a base connector 114. The support strut 160 extends upward at a rearward angle, secured by pin 162 to the arched beams 170 and pin 164 to base connector 166. The arched beams 170 include a first arched beam 170A and a second arched beam 170B, with a plate 175A mounted on 170A and a corresponding plate mounted on 170B (hidden from view to ease illustration of other components including a cable guide 149).

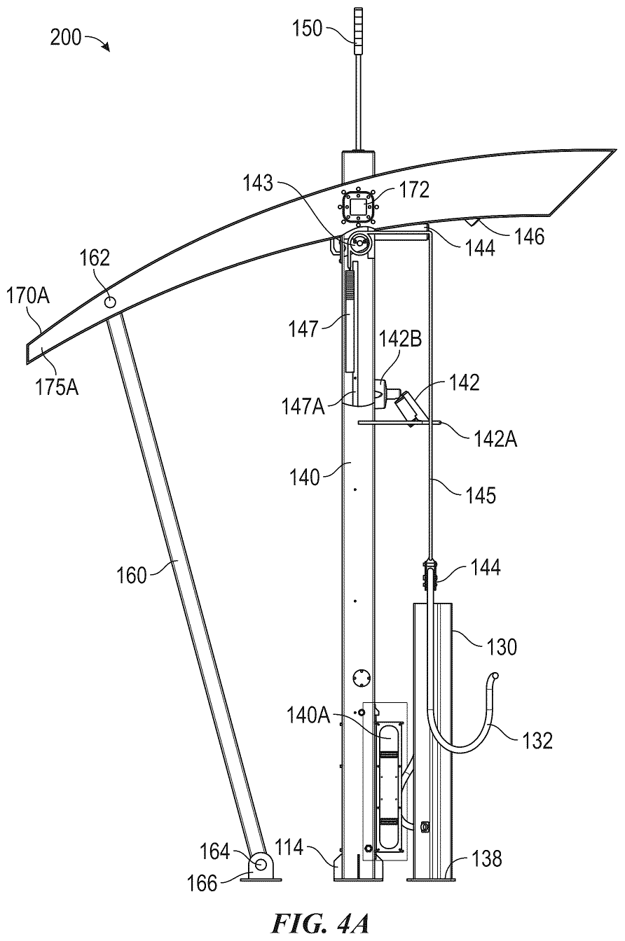

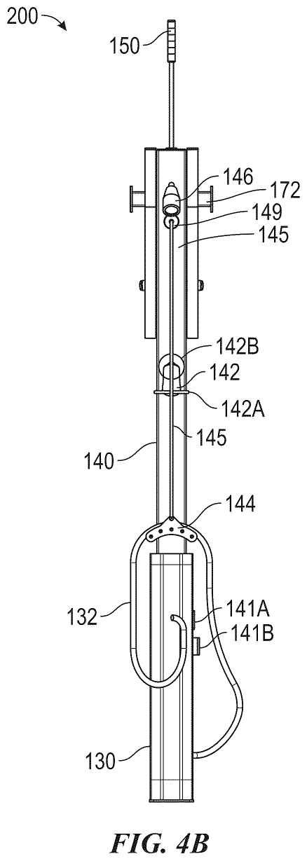

A cable management system includes the guide assembly 144 with sheaves to guide movement of the electrical cable 132. The cable guide 149 directs a suspension cable 145 (shown in FIGS. 3A through 4B). The suspension cable 145 connects between the guide assembly 144 and the smart post 140 to facilitate controlled movement of the guide assembly 144.

While the illustrated embodiment shows the components of the unit 200 mounted on the portable skid 110, the unit 200 may alternatively be implemented in permanent installations where the charging post 130, smart post 140, and/or support strut 160 mount directly to the ground.

The unit 200 integrates charging capabilities with safety features in a modular design. Although the system 100 includes four units 200 as shown in FIGS. 1A-1C, this number may vary.

FIGS. 3A through 3C depict a charging unit in a retracted configuration, while FIGS. 4A and 4B illustrate the charging unit in an extended configuration, in accordance with some embodiments of the present disclosure. Specifically, FIGS. 3A and 3B are perspective and left-side views, respectively, and FIG. 3C is an enlarged view of section 3C of the charging unit 200 in the retracted configuration; FIGS. 4A and 4B are perspective and left-side views of the charging unit 200 in the extended configuration, respectively.

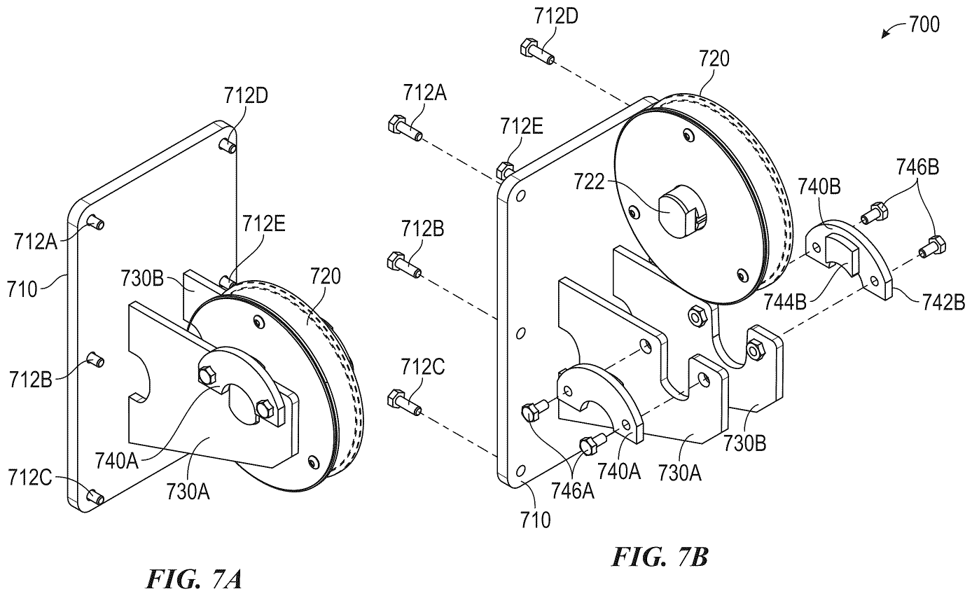

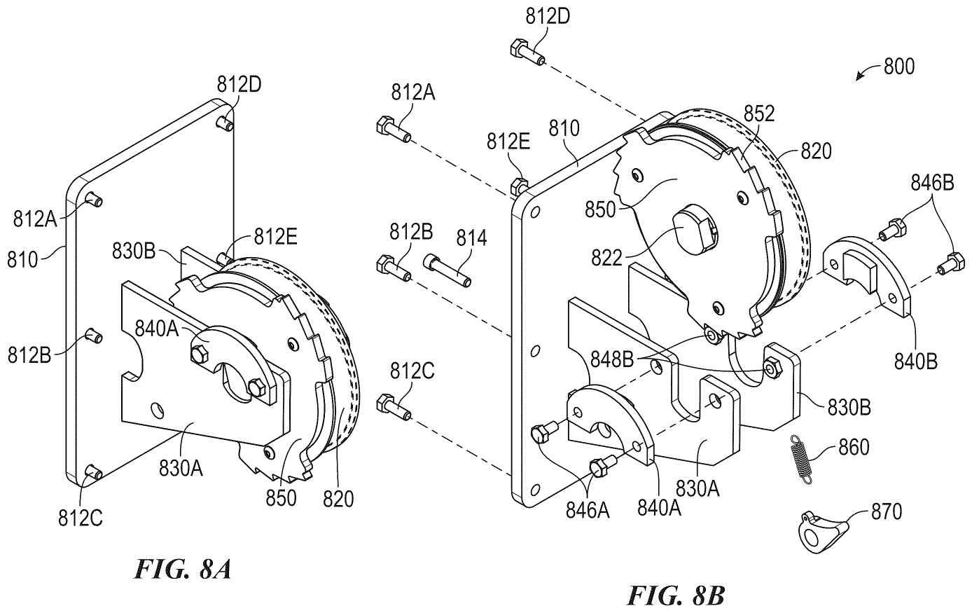

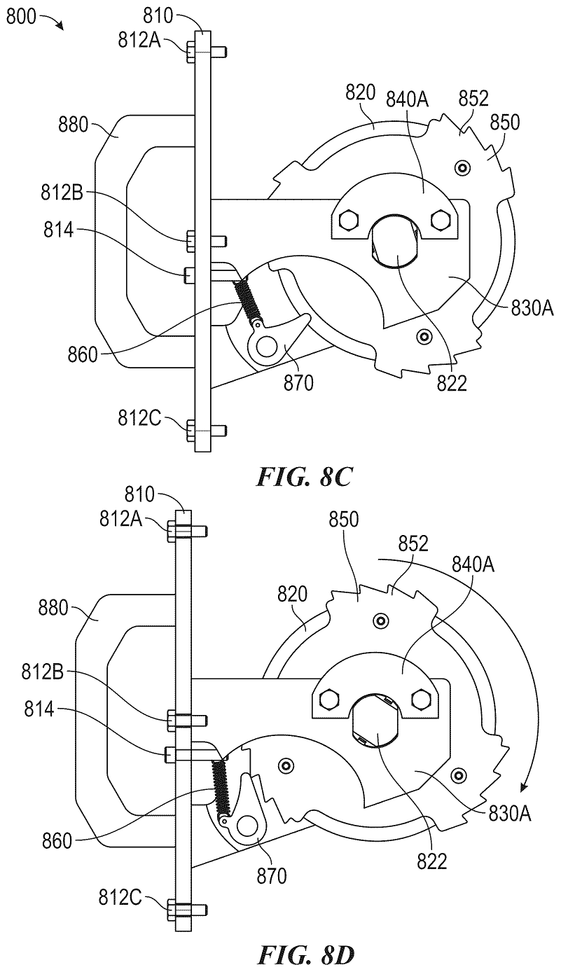

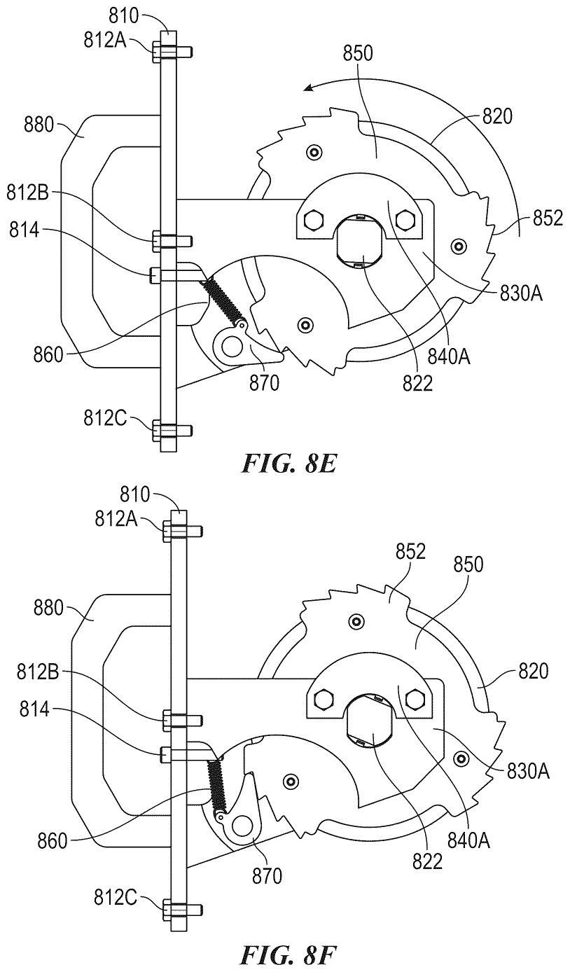

The cable management system of the unit 200 is configured to facilitate handling of the charging cable assembly connected to the charging post 130. The cable management system includes a guide assembly 144 configured to guide movement of the electrical cable 132. The suspension cable 145 has a first end connected to the guide assembly 144 and a second end operatively associated with the smart post 140. The suspension cable 145 is configured to facilitate controlled movement of the guide assembly 144. The suspension cable 145 routes around a pulley wheel (e.g., 720 in FIGS. 7A and 7B, 820 in FIGS. 8A-8F) in a pulley assembly 143, which mounts to the smart post 140. This arrangement enables movement of the guide assembly 144 relative to the smart post 140.

The smart post 140 has an internal cavity that extends along its length and is accessible through a removable cover plate 140A. This cavity can house additional components of unit 200. In some embodiments, the cable management system includes a counterweight assembly 147 movably housed within the cavity. The cavity may also contain a rail 147A designed to guide the movement of the counterweight assembly 147 within the cavity. The rail 147A restricts the counterweight assembly's movement to a primarily vertical direction (or along the rail's alignment) to reduce or minimize the risk of the assembly colliding with or damaging other components within the cavity. The counterweight assembly 147 connects to the guide assembly 144 via the suspension cable 145, enabling the automatic retraction of the guide assembly 144.

In the retracted configuration (FIGS. 3A-3C), the guide assembly 144 is positioned near the cable guide 149 and above the charging post 130 (referred to as the retracted position of the guide assembly 144). Simultaneously, the counterweight assembly 147 is located in a low position near the base of the smart post 140, close to the skid 110 and/or the ground (referred to as the retracted position of the counterweight assembly 147). This arrangement ensures that the electrical cable 132 and the connector 136 are kept elevated and away from the ground.

In the extended configuration (FIGS. 4A-4B), the guide assembly 144 moves toward the charging post 130 and is positioned farther from the cable guide 149 (referred to as the extended position of the guide assembly 144). Simultaneously, the counterweight assembly 147 rises within the cavity to a higher position near the top of the smart post 140 (referred to as the extended position of the counterweight assembly 147). This coordinated movement provides controlled operation of the guide assembly 144 and the charging cable assembly it supports.

The counterweight assembly 147 provides automatic retraction capability through its weight or an alternative counterbalance mechanism, ensuring reliable operation even without user assistance in repositioning the charging cable assembly. When the connector 136 is released from the vehicle, the counterweight assembly 147 automatically returns the guide assembly 144 to its retracted position near the cable guide 149. This movement positions the connector 136 toward the charging post 130 and away from the ground, reducing the risk of tripping hazards, damage from vehicle traffic, or weather exposure.

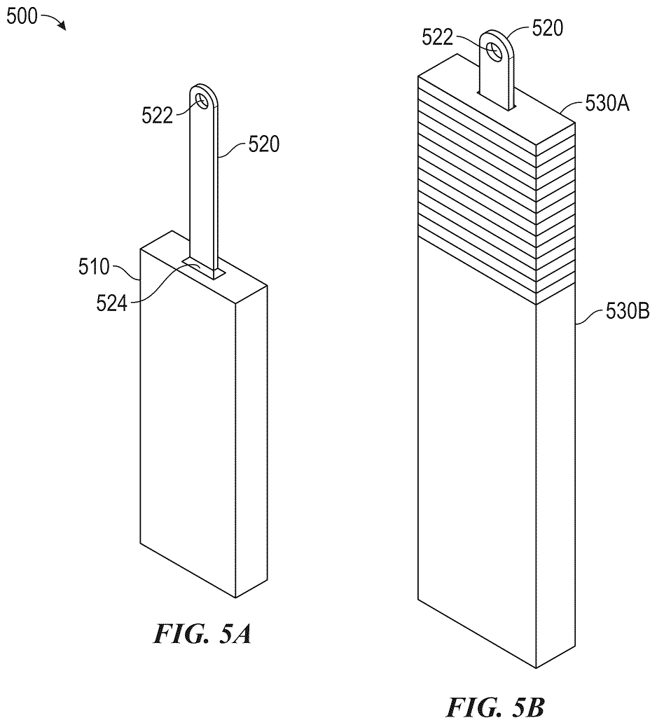

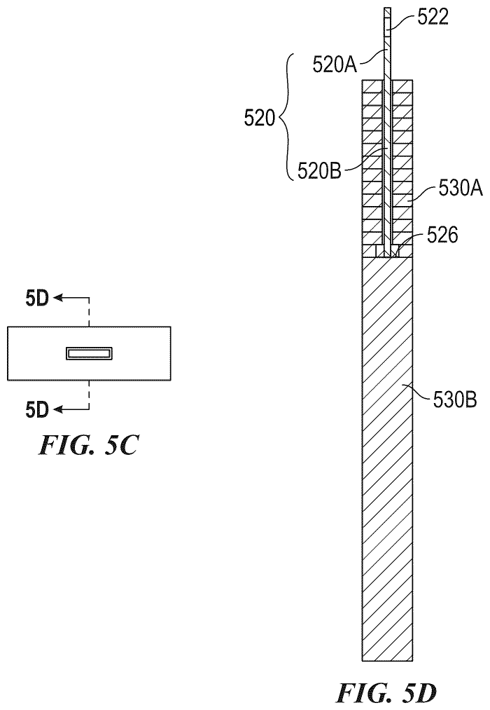

Specifically, FIGS. 5A and 5B provide perspective views of the counterweight assembly 500, with FIG. 5A showing the assembly enclosed in a housing 510 and FIG. 5B showing it without the housing. FIGS. 5C and 5D offer a top view and a cross-sectional view, respectively, of the counterweight assembly 500 without the housing 510. The counterweight assembly 500 represents an implementation of the counterweight assembly 147 described in FIGS. 3A-4B. It is configured to be movably housed within the cavity of the smart post 140 and coupled to the guide assembly 144 via the suspension cable 145.

The counterweight assembly 500 includes a weight body 530. The counterweight assembly 500 may include a housing 510 where the weight body 530 is positioned. The housing 510 may protect the internal components and guides the movement of the assembly within the smart post cavity.

The weight body 530 includes multiple weight plates 530 (respectively identified as 530A and 530B) stacked together. For example, the weight body 530 includes multiple weight plates 530A and a heavier base plate 530B. The multiple weight plates 530A may have uniform or varying weights. This modular design allows adjustment of the total weight by adding or removing weight plates to accommodate different charging cable assembly weights.

The counterweight assembly 500 includes a coupling member 520 configured to connect the counterweight assembly 500 to the suspension cable 145. As illustrated, the coupling member 520 has an opening 522 positioned above the housing 510 to receive and secure the suspension cable 145. A mounting flange 524 is located at the interface between the coupling member 520 and the housing 510. The mounting flange 524 may serve as a mechanical stop to define the vertical position of the coupling member 520 relative to the housing 510.

FIG. 5C shows a top view of the counterweight assembly 500, while FIG. 5D shows a cross-sectional view 5D-5D illustrating the interface between the coupling member 520 and the weight body 530. The coupling member 520 has a first portion 520A extending beyond (e.g., above) a surface of the weight body 530 (or the housing 510) and a second portion 520B extending into the weight body 530 (or the housing 510). The cross-section in FIG. 5D reveals a channel through the weight plates 530A that accommodates the second portion 520B. The second portion 520B connects to the weight plate 530B at an end portion 526. The second portion 520B may be welded or adhered to the weight plate 530B for secure attachment. Additionally or alternatively, the end portion 526 is dimensioned larger than the channel of the weight plates 530A (as illustrated in FIG. 5D), ensuring the second portion 520B remains within the channel even in the event of attachment to the weight plate 530B failure. Alternatively, the coupling member 520 may mount directly to the housing 510's exterior without internal extension (e.g., no 520B).

In some implementations, the counterweight assembly 147 may include components other than weight plates 530 to generate the counterbalancing force. For example, a spring mechanism may provide the needed counterbalance, offering a compact or customizable solution. These alternative designs ensure flexibility in adapting the system to various use cases or design constraints.

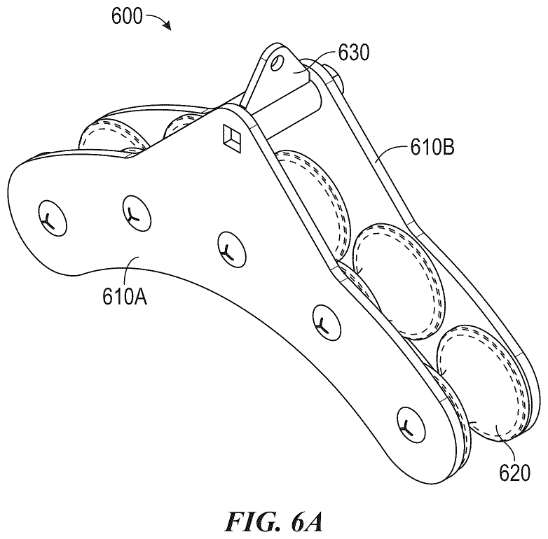

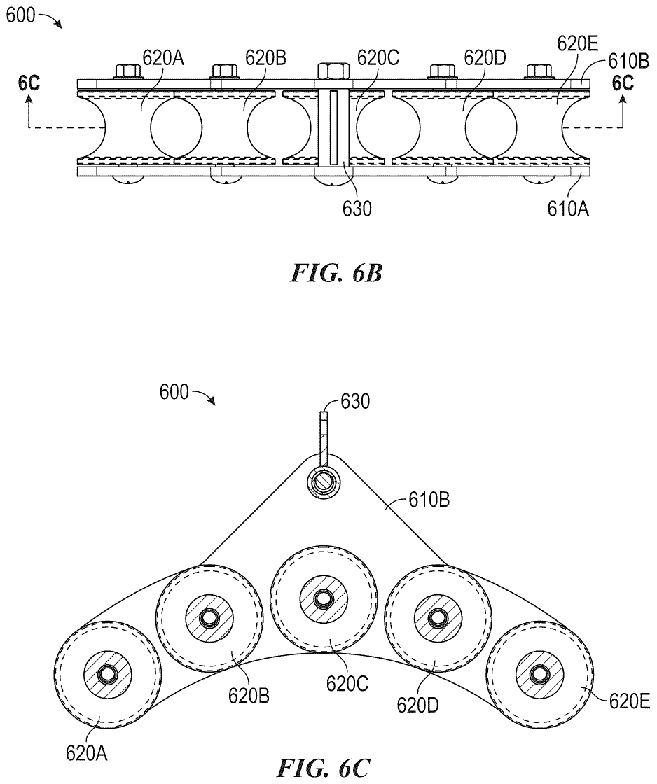

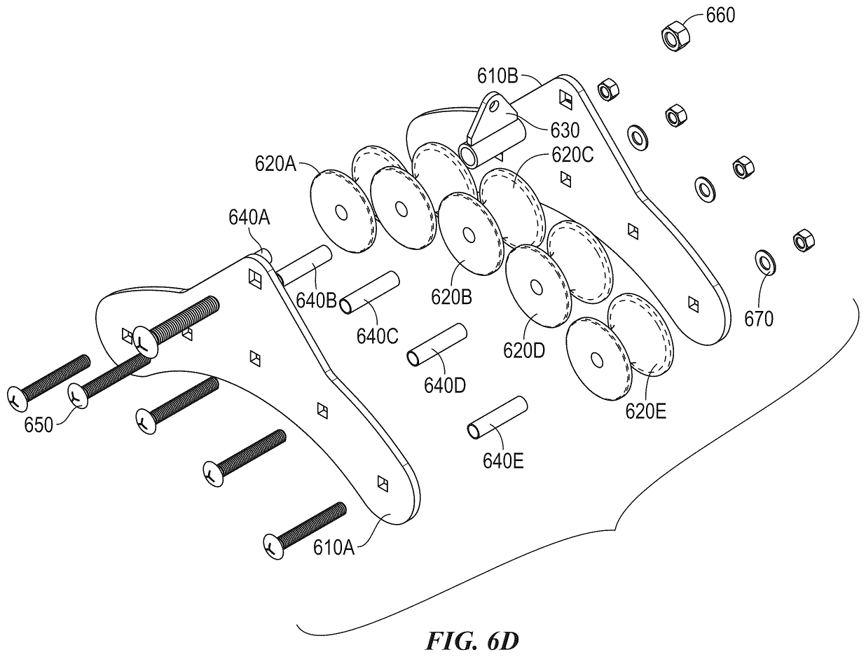

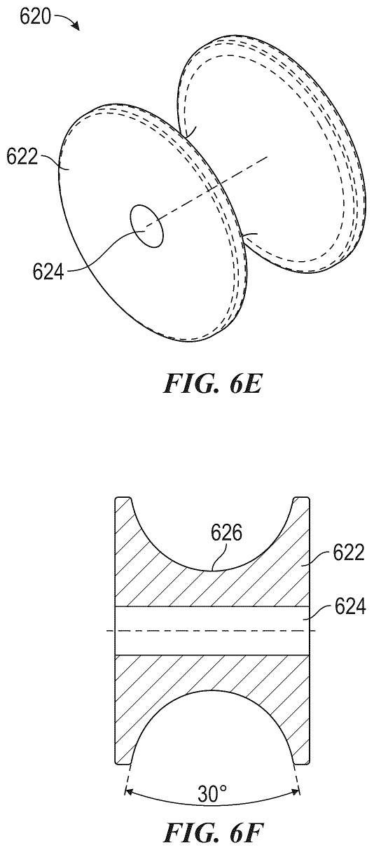

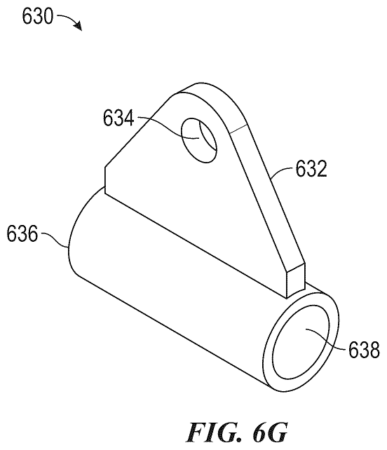

FIGS. 6A through 6G illustrate various views of a guide assembly, in accordance with some embodiments of the present disclosure. Specifically, FIGS. 6A through 6D are perspective, top, cross-sectional, and exploded view of the guide assembly 600, respectively; FIGS. 6E and 6F illustrate a perspective view and a cross-sectional view of a sheave, respectively; FIG. 6G illustrates a perspective view of a cable anchor 630. The guide assembly 600 represents an implementation of the guide assembly 144 described in FIGS. 2-4B.

The guide assembly 600 includes a pair of side plates 610 (individually identified as a first side plate 610A and a second side plate 610B) with multiple sheaves 620 (individually identified as 620A through 620E) rotatably mounted between them. A cable anchor 630 couples the guide assembly 600 to the suspension cable 145 by securing the first end of the suspension cable 145.

As shown in FIGS. 6B and 6C, the sheaves 620 are arranged along a curved path designed to accommodate the bending characteristics of the electrical cable 132. Each sheave 620 features a grooved surface configured to receive and guide the electrical cable 132. The sheaves 620 are independently rotatable to facilitate smooth cable movement.

FIG. 6D provides an exploded view of the guide assembly 600, revealing its components. Each sheave 620 (individually identified as 620A through 620E) is mounted to a bearing 640 (individually identified as 640A through 640E) and positioned between the side plates 610 using a bolt (e.g., carriage bolt) 650 that passes through the bearing 640. The assembly is secured with nuts 660 and washers 670.

FIGS. 6E and 6F provide detailed views of an individual sheave 620. The sheave body 622 includes a central hole 624 designed to accommodate a bearing 640, enabling free rotation. A groove 626 with a curved profile (e.g., a 30° arc in cross-section) is formed around the sheave body 622 to securely cradle and guide the electrical cable 132. This groove 626 allows smooth movement of the cable 132 across the curved surface of a sheave 620.

The sheaves 620 are passive components, rotatable in both directions to accommodate the extension of the electrical cable 132 during charging and its retraction afterward. This bi-directional passive design efficiently manages the movement of the heavy cable 132 without requiring powered mechanisms, reducing complexity and potential failure points.

FIG. 6G illustrates the cable anchor 630, which includes an anchor base 636 and a mounting extension 632. The mounting extension 632 features an opening 634 for receiving the end of the suspension cable 145. The anchor base 636 includes a hole 638 designed to accommodate a bearing 640, allowing the cable anchor 630 to rotate relative to the side plates 610. The cable anchor 630 is mounted to the side plates 610 using a bolt 650 through the bearing 640, ensuring controlled movement of the guide assembly 144 in conjunction with the counterweight assembly 147 or 500.

FIGS. 7A and 7B illustrate perspective and exploded views of a pulley assembly, in accordance with some embodiments of the present disclosure. The pulley assembly 700 represents an implementation of the pulley assembly 143 described in FIGS. 2-4B. The pulley assembly 700 is configured to route the suspension cable 145 to enable controlled movement of the guide assembly 144 relative to the smart post 140.

The pulley assembly 700 includes a mount plate 710 configured to attach to the smart post 140 via mounting fasteners 712 (individually identified as 712A-712E). A pair of pulley mounts 730 (individually identified as a first pulley mount 730A and a second pulley mount 730B) are attached to and extend from the mount plate 710, serving as support brackets.

A pulley wheel 720 is rotatably mounted between the pulley mounts 730 on a shaft 722 that extends between the pulley mounts 730. The pulley wheel 720 includes a grooved surface configured to receive and guide the suspension cable 145. A pair of wheel retainers 740 (individually identified as a first wheel retainer 740A and a second wheel retainer 740B) secure the pulley wheel 720 on the shaft 722 between the pulley mounts 730. Each wheel retainer 740 attaches to its corresponding pulley mount 730 on the outer side (the side opposite to where the pulley wheel 720 is located), secured by the corresponding fastener 746 (individually identified as first fasteners 746A and second fasteners 746B). This arrangement maintains proper alignment of the pulley wheel 720 while allowing free rotation.

The second wheel retainer 740B has a body portion 742B and a shaft portion 744B. The body portion 742B is curved and includes mounting holes at each end to accommodate second fasteners 746B, securing it to the pulley mount 730B. The shaft portion 744B provides additional support for the pulley wheel 720, ensuring smooth rotation around the shaft 722. The first wheel retainer 740A has an identical or substantially similar structure to the second wheel retainer 740B.

This configuration allows the pulley wheel 720 to rotate as the suspension cable 145 moves, facilitating smooth extension and retraction of the guide assembly 144 while maintaining proper cable tension and alignment. For example, in the embodiments where the suspension cable 145 connects the guide assembly 144 and the counterweight assembly 147, as the cable 145 moves, it facilitates controlled extension and retraction of the guide assembly 144, while the counterweight assembly 147 moves oppositely within the smart post cavity, This configuration allows the pulley wheel 720 to rotate as the suspension cable 145 moves, facilitating smooth extension and retraction of the guide assembly 144 while maintaining proper cable tension and alignment. For example, in the embodiments where the suspension cable 145 connects the guide assembly 144 and the counterweight assembly 147, as the cable 145 moves, it facilitates controlled extension and retraction of the guide assembly 144, while the counterweight assembly 147 moves oppositely within the smart post cavity, maintaining cable tension and providing force to automatically move the guide assembly 144, even without user assistance.

FIGS. 8A through 8F illustrate various views of a pulley assembly, in accordance with embodiments of the present disclosure. Specifically, FIGS. 8A and 8B are perspective and exploded views of a pulley assembly 800; FIGS. 8C through 8F are side views of various positions of the pulley assembly 800 during operation. The pulley assembly 800 represents an implementation of the pulley assembly 143 described in FIGS. 2-4B. The pulley assembly 800 is configured to route the suspension cable 145 to enable controlled movement of the guide assembly 144 relative to the smart post 140.

The pulley assembly 800 includes the functionality of pulley assembly 700 and incorporates a ratchet mechanism for controlled directional movement. Similar to the pulley assembly 700, the mount plate 810 attaches to the smart post 140 via mounting fasteners 812 (individually identified as 812A-812E), with an additional bolt 814 for engaging a tension spring 860, as further described below. A pair of pulley mounts 830 (individually identified as a first pulley mount 830A and a second pulley mount 830B) are attached to and extend from the mount plate 810, serving as support brackets. The pulley assembly 800 may include a handle 880 on the opposite side of the mount plate 810 than the pulley mounts 830 to facilitate handling during, e.g., installation, maintenance, or other operations.

A pulley wheel 820 is rotatably mounted between the pulley mounts 830 on a shaft 822 that extends between the pulley mounts 830. The pulley wheel 820 includes a grooved surface configured to receive and guide the suspension cable 145. A pair of wheel retainers 840 (individually identified as a first wheel retainer 840A and a second wheel retainer 840B) secure the pulley wheel 820 on the shaft 822 between the pulley mounts 830. Each wheel retainer 840 attaches to its corresponding pulley mount 830 on the outer side (the side opposite to where the pulley wheel 820 is located), secured by the corresponding fastener 846 (individually identified as first fasteners 746A and second fasteners 746B). The wheel retainers 840 may be identical or similar to the above-discussed wheel retainer 740, the description of which is applicable and not repeated here for brevity.

Unlike the pulley assembly 700, the pulley assembly 800 further includes a ratchet unit configured to selectively restrict the rotation of the pulley wheel 820. The ratchet unit includes a ratchet plate 850 mounted coaxially with the pulley wheel 820. The ratchet plate 850 and the pulley wheel 820 are positioned between the pulley mounts 830 and configured to move together. The ratchet plate 850 includes teeth 852 distributed along at least a portion of its circumference. As illustrated, the teeth 852 are arranged in discrete sections along the circumference of the ratchet plate 850, two neighboring teeth sections, with smooth, toothless sections separating adjacent groups of teeth 852. A pawl 870 is pivotally mounted near the ratchet plate 850 to engage the ratchet plate teeth 852. For example, a first end of the pawl 870 is pivotally mounted to the mount plate 810 or the pulley mount 830, and a second end of the pawl 870 is configured to selectively engage with the teeth 852 of the ratchet plate 850. A tension spring 860 biases the pawl 870 toward engagement with the teeth 852. The tension spring 860 is attached to the mount plate 810 using the bolt 814.

This ratchet mechanism allows unidirectional rotation of the pulley wheel 820, while selectively preventing reverse movement. When the pawl 870 engages the teeth 852, it locks the ratchet plate 850, and consequently the pulley wheel 820 in place to prevent backward movement of to the ratchet plate 850. The pawl 870 can be disengaged by manipulating the tension spring 860, allowing the ratchet plate 850 and the pulley wheel 820 to move bi-directionally as needed.

FIGS. 8C through 8F show various operational positions of the pulley assembly 800, in accordance with embodiments of the present technology. In each of FIGS. 8C through 8F, a portion of the wheel retainer 840A is removed to expose the ratchet plate 850, tension spring 860, and pawl 870, which would otherwise be obscured.

FIG. 8C shows a spring neutral position. In this position, the pawl 870 rests against a smooth section of the ratchet plate 850, unengaged with any teeth. The tension spring 860 maintains contact between the pawl 870 and the smooth section of the circumference of the ratchet plate 850, ready for engagement with a tooth 852. The ratchet plate 850 and the pulley wheel 820 can rotate in either direction. The rotation of the pulley wheel 820 occurs as it guides the suspension cable 145 through the groove 822.

FIG. 8D shows a ratcheting position. In this position, the pulley wheel 820 rotates in the allowed direction (indicated by the arrow) as the suspension cable 145 moves through the groove 822. While the pulley wheel 820 rotates, the pawl 870 rides over the angled surfaces of the teeth 852. Each tooth 852 temporarily pushes the pawl 870 against the spring force to briefly disengage the pawl 870 from the tooth 852, allowing passage. After the tooth passes, the spring 860 forces the pawl 870 back into engagement with the angled surface of the next tooth 852. The spring 860 maintains engagement pressure on the pawl 870 to ensure controlled movement of the ratchet plate 850 and the pulley wheel 820 in the allowed direction while preventing counter-rotation (e.g., as illustrated in FIG. 8F).

FIG. 8E show a retracting position. In this position, the pawl 870 is pulled away from the teeth 852 of the ratchet plate 850, overcoming the bias of the tension spring 860. With the pawl 870 disengaged, the ratchet plate 850 and the pulley wheel 820 are free to rotate in either direction. This configuration allows unrestricted bidirectional movement of the suspension cable 145 through the groove 822, enabling manual adjustment or retraction as needed.

FIG. 8F shows a locked position. In this position, the pawl 870 remains engaged with the teeth 852 of the ratchet plate 850, locking the ratchet plate 850 and the pulley wheel 820 against counterclockwise rotation. While rotation in the counterclockwise direction is prevented, the ratchet plate 850 and the pulley wheel 820 can still rotate clockwise. This configuration ensures controlled unidirectional movement of the suspension cable 145 in the groove 822 while preventing backward motion.

The pulley assembly 800 may seamlessly transition between different positions as illustrated in FIGS. 8C through 8F without requiring a user to directly maneuver any parts of the pulley assembly 800. For example, the transition may occur due to the tension changes in the suspension cable 145, which occur naturally as the user pulls or releases the charging cable assembly, or as the counterweight assembly 147 acts during retraction. The suspension cable 145 transmits tension to the pawl 870, which engages with or disengages from the teeth 852 of the ratchet plate 850. The spring 860 biases the pawl 870, keeping it engaged with the teeth 852 unless the tension from the suspension cable 145 disengages it. Merely by way of example, the pulley assembly 800 includes a cam or lever, connected to the suspension cable 145, translating tension changes into movement of the pawl 870, ensuring the pulley assembly 800 transitions smoothly between operational positions. Additionally or alternatively, the pulley assembly 800 includes a pivot arm or linkage connecting the cam to the pawl 870, allowing the tension in the suspension cable 145 to directly control the spring 860's compression or release, thereby enabling the required positional transitions.

The operation of the pulley assembly 800 involves transitions between several positions to accommodate different stages of charging. During the pulling of the charging cable assembly in preparation for charging, the pulley assembly 800 operates in the position shown in FIG. 8C or 8D. In this position, the pulley wheel 820 is allowed to rotate in a first direction (e.g., clockwise), enabling the controlled extension of the charging cable assembly while preventing retraction. During charging or when the charging cable assembly is at rest, the pulley assembly 800 locks into the position illustrated in FIG. 8F. After charging is completed and the charging cable assembly retracts, the pulley assembly 800 transitions to the position shown in FIG. 8E. In this position, the pulley wheel 820 is able to rotate in a second direction opposite to the first direction (e.g., counterclockwise), allowing smooth retraction of the charging cable assembly. This sequence of transitions ensures the efficient and secure handling of the charging cable assembly, accommodating pulling, locking, and retraction scenarios seamlessly.

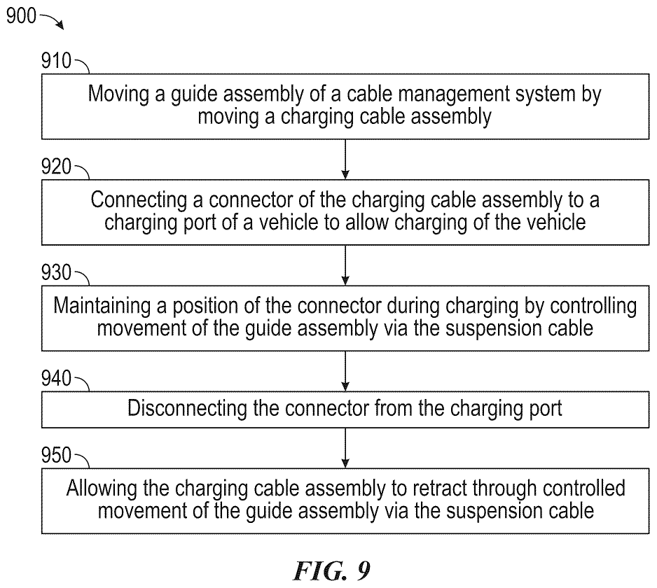

FIG. 9 is a flowchart illustrating a process for charging a vehicle using a cable management system, in accordance with some embodiments of the present disclosure. The vehicle may be an EV, a hybrid vehicle, etc. The process 900 includes at 910 moving a guide assembly (e.g., guide assembly 144 or 600) of a cable management system by moving a charging cable assembly. The charging cable assembly includes an electrical cable (e.g., electrical cable 132) and a connector (e.g., connector 136) at an end of the electrical cable. The guide assembly includes a plurality of sheaves (e.g., 520). The electrical cable is movably supported by the plurality of sheaves of the guide assembly. The cable management system further includes a suspension cable (e.g., suspension cable 145) having a first end coupled to the guide assembly and a second end operatively associated with a smart post (e.g., smart post 140). the suspension cable is configured to facilitate controlled movement of the guide assembly.

In some embodiments, the suspension cable is routed around a pulley assembly (e.g., pulley assembly 143, 700, or 800) mounted to the smart post to enable movement of the guide assembly. The movement of the guide assembly is controlled by selectively allowing movement of the guide assembly in a first direction while selectively preventing movement in a second direction via a ratchet unit of the pulley assembly. For example, the ratchet unit includes a ratchet plate with teeth distributed along portions of its circumference, a pawl configured to selectively engage the teeth, and a tension spring. Movement of the guide assembly is controlled by engaging a pawl with the teeth of a ratchet plate to prevent movement of the guide assembly in one direction, and disengaging the pawl from the teeth to allow movement of the guide assembly in the direction. The pawl is configured to pivot into engagement with the teeth under a spring force, and/or pivot out of engagement with the teeth against the spring force.

For example, during a preparation stage for charging, a user pulls the charging cable assembly toward the EV, the pulley assembly 143 (e.g., pulley assembly 800) operates in a ratcheting position (FIG. 8D) or a spring neutral position (FIG. 8C). In the spring neutral position, the pawl 870 rests on a smooth section of the ratchet plate 850, allowing the pulley wheel 820 to rotate freely in either direction until the pawl 870 encounters the teeth 852. Once the pawl 870 engages the teeth 852, the ratcheting mechanism activates, permitting the pulley wheel 820 to rotate in a first direction (e.g., clockwise) to extend the guide assembly (e.g., guide assembly 144 or 600) and the charging cable assembly toward the EV. However, the ratchet mechanism prevents counterclockwise rotation, thereby blocking retraction. If the assembly starts in the ratcheting position, the pawl 870 is already engaged with the teeth, enabling the same functionality. In either case, the charging cable assembly extends smoothly and remains stable during pulling, with no or limited unintended backward movement, ensuring user convenience and operational control.

The process 900 includes at 920 connecting the connector to a charging port of the vehicle to allow charging of the vehicle. The process 900 includes at 930 maintaining a position of the connector during charging by controlling the movement of the guide assembly via the suspension cable.

The position of the connector may be maintained during charging by counterbalancing a weight of the charging cable assembly via a counterweight assembly (e.g., counterweight assembly 147 or 500) coupled to the guide assembly through the suspension cable.

For example, during the charging stage, the pulley assembly (e.g., pulley assembly 143 or 800) transitions to the locked position (FIG. 8F). In this position, the pawl 870 is fully engaged with the teeth 852 of the ratchet plate 850, preventing the pulley wheel 820 from rotating in a second direction (e.g., counterclockwise) opposite to the first direction. Additionally, rotation of the pulley wheel 820 in the first direction (e.g., clockwise) may be prevented or restricted by the counterbalancing force exerted by the counterweight assembly 147 or 500. Consequently, the pulley wheel 820 remains (substantially) stationary, the suspension cable 145 does not move, and the guide assembly and the charging cable assemble remain stable. The locked position of the pulley assembly, in cooperation with the counterweight assembly, ensures the guide assembly and the charging cable assemble (including the connector 136) remains secure during charging. This prevents unnecessary strain on the suspension cable and/or eliminates or reduces potential misalignment of components.

The process 900 includes at 940 disconnecting the connector from the charging port. The process 900 includes at 950 allowing the charging cable assembly to retract through controlled movement of the guide assembly via the suspension cable.

For example, after charging is completed, as the charging cable assembly retracts to prevent the connector 136 from dropping to the ground, and the pulley assembly (e.g., pulley assembly 143 or 800) transitions to the retracting position (FIG. 8E). In this position, the pawl 870 disengages from the teeth 852 of the ratchet plate 850, allowing the pulley wheel 820 to rotate in both directions. This facilitates smooth retraction of the electrical cable 132, driven by the counterbalancing force provided by a counterweight assembly (e.g., counterweight assembly 147 or 500). The counterweight assembly ensures that the guide assembly and electrical cable 132 remain elevated and do not move downward, even though the pulley assembly is not locked in this position. The counterweight's force naturally opposes downward movement, preventing the connector 136 from falling or remaining on the ground.

During the rest stage when the connector 136 is attached to the charging post 130 by, e.g., being placed in a receptacle, the pulley assembly (e.g., pulley assembly 143 or 800) remains in the locked position (FIG. 8F), the counterweight assembly (e.g., counterweight assembly 147 or 500) prevents rotation in the opposite direction, similar to the configuration of the cable management system during the charging stage described at 920. This locked configuration ensures that the guide assembly and the charging cable assembly remain stationary and secure, maintaining the system's stability and alignment.

Some embodiments may implement one or more of the following solutions, listed in clause-format. The following clauses are supported and further described in the embodiments above and throughout this document.
Solution 1. A charging system, comprising: a skid; a smart post attached to and extending away from the skid; a charging post mounted on the skid; and a cable management system comprising: a guide assembly including a plurality of sheaves to guide movement of an electrical cable; and a suspension cable having a first end coupled to the guide assembly and a second end operatively associated with the smart post, the suspension cable being configured to facilitate controlled movement of the guide assembly.
Solution 2. A charging system, comprising: a smart post; a charging post; and a cable management system comprising: a guide assembly including a plurality of sheaves to guide movement of an electrical cable; and a suspension cable having a first end coupled to the guide assembly and a second end operatively associated with the smart post, the suspension cable being configured to facilitate controlled movement of the guide assembly.
Solution 3. The charging system of any one or more solutions described herein, wherein the plurality of sheaves are arranged in a curved path.
Solution 4. The charging system of any one or more solutions described herein, wherein at least one of the plurality of sheaves comprises a grooved surface configured to receive the electrical cable.
Solution 5. The charging system of any one or more solutions described herein, wherein the guide assembly comprises: a pair of side plates, wherein the plurality of sheaves are rotatably mounted between the side plates.
Solution 6. The charging system of any one or more solutions described herein, wherein: each of the plurality of sheaves is coupled to a bearing and rotatably mounted to the side plates using a bolt extending through the bearing.
Solution 7. The charging system of any one or more solutions described herein, wherein the plurality of sheaves are independently rotatable.
Solution 8. The charging system of any one or more solutions described herein, wherein the guide assembly further comprises a cable anchor that is mounted to the side plates and configured to receive the first end of the suspension cable.
Solution 9. The charging system of any one or more solutions described herein, wherein the cable anchor is coupled to a bearing and rotatably mounted to the side plates using a bolt extending through the bearing.
Solution 10. The charging system of any one or more solutions described herein, wherein: the smart post has a cavity extending along a length direction; and the cable management system further comprises a counterweight assembly moveably housed within the cavity and coupled to the guide assembly via the suspension cable.
Solution 11. The charging system of any one or more solutions described herein, wherein the counterweight assembly comprises: a weight body, and a coupling member configured to connect to the second end of the suspension cable.
Solution 12. The charging system of any one or more solutions described herein, wherein the coupling member has a first portion extending beyond a surface of the weight body and a second portion extending into the weight body.
Solution 13. The charging system of any one or more solutions described herein, wherein the counterweight assembly comprises a housing within which the weight body is positioned.
Solution 14. The charging system of any one or more solutions described herein, wherein the coupling member is coupled to a surface of the housing.
Solution 15. The charging system of any one or more solutions described herein, wherein the weight body comprises a plurality of weight plates.
Solution 16. The charging system of any one or more solutions described herein, wherein: the cable management system further comprises a pulley assembly mounted to the smart post; and the suspension cable is routed around the pulley assembly to enable movement of the guide assembly relative to the smart post.
Solution 17. The charging system of any one or more solutions described herein, wherein the pulley assembly comprises: a mount plate configured to attach to the smart post; a pulley mount secured to the mount plate; and a pulley wheel rotatably mounted to the pulley mount.
Solution 18. The charging system of any one or more solutions described herein, wherein: the pulley wheel comprises a grooved surface configured to receive the suspension cable.
Solution 19. The charging system of any one or more solutions described herein, wherein: the pulley mount comprises a pair of support brackets attached to and extending from the mount plate; and the pulley wheel is rotatably mounted between the support brackets.
Solution 20. The charging system of any one or more solutions described herein, wherein: the pulley wheel is mounted on a shaft extending between the support brackets.
Solution 21. The charging system of any one or more solutions described herein, further comprising a wheel retainer configured to secure the pulley wheel on the shaft between the support brackets.
Solution 22. The charging system of any one or more solutions described herein, wherein: the pulley assembly comprises a ratchet unit configured to allow rotation of the pulley wheel in a first direction while selectively preventing rotation in a second direction opposite to the first direction.
Solution 23. The charging system of any one or more solutions described herein, wherein the ratchet unit comprises: a ratchet plate having teeth along at least a portion of a circumference of the ratchet plate; and a pawl pivotally configured to engage with the teeth of the ratchet plate.
Solution 24. The charging system of any one or more solutions described herein, wherein the pawl is spring-biased to facilitate engagement with the teeth of the ratchet plate.
Solution 25. The charging system of any one or more solutions described herein, wherein the pawl comprises: a first end pivotally mounted to the mount plate or the pulley mount; and a second end configured to selectively engage with the teeth of the ratchet plate.
Solution 26. A method of charging a vehicle, the method comprising: moving a guide assembly of a cable management system by moving a charging cable assembly, wherein: the charging cable assembly comprises an electrical cable and a connector at an end of the electrical cable, the guide assembly includes a plurality of sheaves; the electrical cable is movably supported by the plurality of sheaves of the guide assembly; and the cable management system further comprises a suspension cable having a first end coupled to the guide assembly and a second end operatively associated with a smart post, the suspension cable being configured to facilitate controlled movement of the guide assembly; connecting the connector to a charging port of the vehicle to allow charging of the vehicle; maintaining a position of the connector during charging by controlling movement of the guide assembly via the suspension cable; disconnecting the connector from the charging port; and allowing the charging cable assembly to retract through controlled movement of the guide assembly via the suspension cable.
Solution 27. The method of any one or more solutions described herein, wherein: the suspension cable is routed around a pulley assembly mounted to the smart post to enable movement of the guide assembly.
Solution 28. The method of any one or more solutions described herein, wherein: controlling movement of the guide assembly comprises selectively allowing movement of the guide assembly in a first direction while selectively preventing movement in a second direction via a ratchet unit of the pulley assembly.
Solution 29. The method of any one or more solutions described herein, wherein: controlling movement of the guide assembly comprises: engaging a pawl with teeth of a ratchet plate to prevent movement of the guide assembly in one direction; and disengaging the pawl from the teeth to allow movement of the guide assembly in the one direction.
Solution 30. The method of any one or more solutions described herein, wherein engaging the pawl comprises allowing the pawl to pivot under a spring force into engagement with the teeth.
Solution 31. The method of any one or more solutions described herein, wherein disengaging the pawl comprises pivoting the pawl against a spring force out of engagement with the teeth.
Solution 32. The method of any one or more solutions described herein, wherein: maintaining the position of the connector during charging comprises counterbalancing a weight of the charging cable assembly via a counterweight assembly coupled to the guide assembly through the suspension cable.
Solution 33. The method of any one or more solutions described herein, wherein: the counterweight assembly is moveably housed within a cavity of the smart post; and allowing the charging cable assembly to retract comprises moving the guide assembly under a counterbalancing force of the counterweight assembly.

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. The terms “about,” “approximately,” and “substantially” as used herein shall be interpreted to mean within ±10% of the stated value. Additionally, all ranges disclosed herein are to be understood to encompass the endpoints, and any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. A charging system, comprising:
a skid;
a smart post attached to and extending away from the skid;
a charging post mounted on the skid; and
a cable management system comprising:
a guide assembly including a plurality of sheaves to guide movement of an electrical cable; and
a suspension cable having a first end coupled to the guide assembly and a second end operatively associated with the smart post, the suspension cable being configured to facilitate controlled movement of the guide assembly.

2. The charging system of claim 1, wherein the plurality of sheaves are arranged in a curved path.

3. The charging system of claim 1, wherein at least one of the plurality of sheaves comprises a grooved surface configured to receive the electrical cable.

4. The charging system of claim 1, wherein the guide assembly comprises:
a pair of side plates, wherein the plurality of sheaves are rotatably mounted between the side plates.

5. The charging system of claim 1, wherein:
the smart post has a cavity extending along a length direction; and
the cable management system further comprises a counterweight assembly moveably housed within the cavity and coupled to the guide assembly via the suspension cable.

6. The charging system of claim 5, wherein the counterweight assembly comprises:
a weight body, and
a coupling member configured to connect to the second end of the suspension cable.

7. The charging system of claim 1, wherein:
the cable management system further comprises a pulley assembly mounted to the smart post; and
the suspension cable is routed around the pulley assembly to enable movement of the guide assembly relative to the smart post.

8. The charging system of claim 7, wherein the pulley assembly comprises:
a mount plate configured to attach to the smart post;
a pulley mount secured to the mount plate; and
a pulley wheel rotatably mounted to the pulley mount.

9. The charging system of claim 8, wherein:
the pulley wheel comprises a grooved surface configured to receive the suspension cable.

10. The charging system of claim 8, wherein:
the pulley assembly comprises a ratchet unit configured to allow rotation of the pulley wheel in a first direction while selectively preventing rotation in a second direction opposite to the first direction.

11. The charging system of claim 10, wherein the ratchet unit comprises:
a ratchet plate having teeth along at least a portion of a circumference of the ratchet plate; and
a pawl pivotally configured to engage with the teeth of the ratchet plate.

12. The charging system of claim 11, wherein the pawl is spring-biased to facilitate engagement with the teeth of the ratchet plate.

13. The charging system of claim 11, wherein the pawl comprises:
a first end pivotally mounted to the mount plate or the pulley mount; and
a second end configured to selectively engage with the teeth of the ratchet plate.

14. A method of charging a vehicle, the method comprising:
moving a guide assembly of a cable management system by moving a charging cable assembly, wherein:
the charging cable assembly comprises an electrical cable and a connector at an end of the electrical cable,
the guide assembly includes a plurality of sheaves;
the electrical cable is movably supported by the plurality of sheaves of the guide assembly; and
the cable management system further comprises a suspension cable having a first end coupled to the guide assembly and a second end operatively associated with a smart post, the suspension cable being configured to facilitate controlled movement of the guide assembly;
connecting the connector to a charging port of the vehicle to allow charging of the vehicle;
maintaining a position of the connector during charging by controlling movement of the guide assembly via the suspension cable;
disconnecting the connector from the charging port; and
allowing the charging cable assembly to retract through controlled movement of the guide assembly via the suspension cable.

15. The method of claim 14, wherein:
the suspension cable is routed around a pulley assembly mounted to the smart post to enable movement of the guide assembly.

16. The method of claim 15, wherein:
controlling movement of the guide assembly comprises selectively allowing movement of the guide assembly in a first direction while selectively preventing movement in a second direction via a ratchet unit of the pulley assembly.

17. The method of claim 15, wherein controlling movement of the guide assembly comprises:
engaging a pawl with teeth of a ratchet plate to prevent movement of the guide assembly in one direction; and
disengaging the pawl from the teeth to allow movement of the guide assembly in the one direction.

18. The method of claim 17, wherein:
engaging the pawl comprises allowing the pawl to pivot under a spring force into engagement with the teeth; and
disengaging the pawl comprises pivoting the pawl against the spring force out of engagement with the teeth.

19. The method of claim 14, wherein:
maintaining the position of the connector during charging comprises:
counterbalancing a weight of the charging cable assembly via a counterweight assembly coupled to the guide assembly through the suspension cable; and
allowing the charging cable assembly to retract comprises moving the guide assembly under a counterbalancing force of the counterweight assembly.

20. A charging system, comprising:
a smart post;
a charging post; and
a cable management system comprising:
a guide assembly including a plurality of sheaves to guide movement of an electrical cable; and
a suspension cable having a first end coupled to the guide assembly and a second end operatively associated with the smart post, the suspension cable being configured to facilitate controlled movement of the guide assembly.
